(19) United States
(12) Patent Application Publication
(10) Pub. No.: US 2009/0180690 A1
(43) Pub. Date: Jul. 16, 2009

(54) IMAGE SEARCHING APPARATUS AND IMAGE SEARCHING METHOD

(76) Inventors: Zhi-Gang FAN, Shanghai (CN); Jilin LI, Shanghai (CN); Yadong WU, Shanghai (CN); Bo WU, Shanghai (CN)

Correspondence Address: BIRCH STEWART KOLASCH & BIRCH, PO BOX 747, FALLS CHURCH, VA, 22040-0747, US

(21) Appl. No.: 12/336,116

(22) Filed: Dec. 16, 2008

(30) Foreign Application Priority Data
Jan. 14, 2008 (CN) 20081000707.7

(51) Int. Cl. G06K 9/00

(52) U.S. Cl. 382/170

(57) ABSTRACT

When the gray processing section converts input image data into gray image data, the histogram generating section generates a histogram that represents the distribution of the number of pixels of the gray image data. Then, based on the gray level of a target pixel and the gray levels of a plurality of neighbor pixels surrounding the target pixel in the shape of an approximate circumference, rotation-invariant features indicating local texture feature centering on the target pixel are calculated for each of the pixels, and a histogram is generated based on the calculated feature. Thereafter, the search section searches for similar image data based on the histogram of the registration image data and the histogram of the input image data, and the display section displays the result of search.

### CROSS-REFERENCE TO RELATED APPLICATION

This application claims priority to Chinese Patent Application No. 200810000707.7, which was filed on Jan. 14, 2008, the contents of which are incorporated herein by reference in its entirety.

### BACKGROUND OF THE INVENTION

1. Field of the Invention

The present invention relates to an image searching apparatus and an image searching method capable of searching image data similar to inputted image data among pre-registered image data.

2. Description of the Related Art

There are image forming apparatuses such as a copy machine, a facsimile machine, a printer, and a multifunctional peripheral having multiple functions thereof that have a function for storing image data such as an inputted document image in a mass-capacity storage device and reading out and outputting registration image data that has been inputted once at any time.

The function for outputting is convenient. However, when the amount of registered data increases, it is difficult to find data to be outputted. Accordingly, image searching technology for searching a desired image from a plurality of image data becomes important.

As conventional image searching technology, for example, there are an image searching method based on a color histogram and a texture, an image searching method using edge feature, and the like.

For example, in Chinese Patent Application No. 02100946.5, an image searching method using a combination of colors and textures has been described, and an image is represented by using color information and texture information of image data. In addition, in an image searching apparatus and an image searching method disclosed in Chinese Patent Application No. 200510067394.3, an image is represented by using color information and basic geometrical information such as ratios of heights.

In addition, in Chinese Patent Application No. 03134425.9, an image searching method using distinguished edges has been described. In the image searching method, first, detection of edges and a thinning process are performed, thereafter a strongest edge is selected, and three features including the ratio of branches (forks), the frequency of rotation, and the ratio of corners are extracted for each selected edge so as to generate a feature vector. Then, a matching process is performed by using the generated feature vector, and similarity between an input image and a registered image is calculated.

In the conventional image searching method, a search process is performed by using a color histogram and a texture, and most of the features depend on the distribution of colors. The features of color information include rotation invariance (even when rotation of an image is generated by placing a document tilted in a document reading device and being read in a document reading process, the accuracy of image searching for the rotated image can be maintained), scale invariance (the accuracy of image searching for an image whose scale or resolution has been converted can be maintained), and robustness (tolerance) for low-grade occlusion (a hidden area that is generated in generating image data due to a photographing angle for the subject at a time when the subject is photographed by a camera). However, conceptual features of a person's vision cannot be sufficiently reflected by a color distribution. Thus, there are actually different images that are determined to be similar in consideration of only the color distribution, and accordingly, there is a high possibility that a search process using only the color distribution is not sufficient. In particular, for a gray image, the accuracy and robustness of the search markedly decrease. In addition, the features represented by the color distribution have a high influence on the speed of search.

In addition, the conventional image searching method using gray information cannot respond to rotation or occlusion, and accordingly, the accuracy of search is lowered.

### SUMMARY OF THE INVENTION

An object of the invention is to provide an image searching apparatus and an image searching method capable of increasing robustness for rotation, occlusion, or the like.

The invention provides an image searching apparatus that searches for image data similar to inputted image data among pre-registered image data, comprising:

a gray processing section that converts the inputted image data into gray image data based on gray levels of the inputted image data and the pre-registered image data;

a histogram generating section that sets one of pixels constituting the gray image data as a target pixel, calculates for each of the pixels rotation-invariant features indicating local texture feature centering on the target pixel based on the gray level of the target pixel and the gray levels of a plurality of neighbor pixels surrounding the target pixel in an approximate circumference shape, and generates a histogram that represents the distribution of the number of pixels of the gray image data based on the calculated features;

a search section that searches for image data similar to the inputted image data among the pre-registered image data based on histograms of the pre-registered image data and the histogram of the inputted image data; and

a display section that displays the image data similar to the inputted image data among the pre-registered image data based on the result of the search performed by the search section.

According to the image searching apparatus, when the gray processing section converts the inputted image data into the gray image data based on the gray levels of the inputted image data and the pre-registered image data, the histogram generating section generates a histogram that represents the distribution of the number of pixels of the gray image data.

In particular, one of pixels constituting the gray image data is set as a target pixel, rotation-invariant features indicating local texture feature centering on the target pixel are calculated for each of the pixels based on the gray scale level of the target pixel and the gray levels of a plurality of neighbor pixels surrounding the target pixel in an approximate circumference shape, and a histogram is generated based on the calculated features.

When the search section searches for image data similar to the inputted image data among the pre-registered image data based on histograms of the pre-registered image data and the histogram of the inputted image data, the display section displays the image data similar to the inputted image data among the pre-registered image data.

As described above, the histogram is generated based on the local pattern, and accordingly, the features that have rotation invariance and scale invariance can be used, and robustness for rotation, optical occlusion, or the like can be improved.

Furthermore, in the invention, it is preferable that the histogram generating section compares the gray level of the target pixel with the gray levels of the neighbor pixels so as to represent the result of comparison for each of the neighbor pixels as a binary logic value, generates byte data by aligning the logic values of the results of comparison in bits in accordance with the order of arrangement of the neighbor pixels, and calculates as the rotation-invariant features byte data in which arrangement of bit values is changed so as to satisfy a predetermined condition by circularly shifting each bit value of the generated byte data.

According to the invention, the histogram generating section compares the gray level of the target pixel with the gray levels of the neighbor pixels so as to represent the result of comparison for each of the neighbor pixels as a binary logic value and generates byte data by aligning the logic values of the results of comparison in bits in accordance with the order of arrangement of the neighbor pixels. In addition, the histogram generating section calculates as the rotation-invariant features byte data in which arrangement of bit values is changed so as to satisfy a predetermined condition by circularly shifting each bit value of the generated byte data.

Accordingly, the rotation-invariant feature can be calculated in an easy manner, and by handling the feature as the byte data, the speed of calculation can increase.

Furthermore, in the invention, it is preferable that the histogram generating section determines an arrangement pattern of bit values of the changed byte data for each of the pixels, divides the gray image data into pixel groups each formed of pixels having a same arrangement pattern, generates a histogram in which gray levels are set as classes for each of the pixel groups and the numbers of pixels included in the classes are set as frequencies, and generates a histogram representing the distribution of the number of the pixels of the total gray image data by combining the histograms generated for each of the pixel groups.

According to the invention, the histogram generating section determines an arrangement pattern of bit values of the changed byte data for each of the pixels and divides the gray image data into pixel groups formed of pixels having a same arrangement pattern. Then, the histogram generating section generates a histogram in which gray levels are set as classes for each of the pixel groups and the numbers of pixels included in the classes are set as frequencies, and generates a histogram representing the distribution of the number of the pixels of the whole gray image data by combining the histograms generated for each of the pixel groups.

Since the histogram of the whole image data is generated by combining the histograms of small areas for the respective pixel groups, the histogram of the total image data can be generated in an easy manner. In addition, by dividing the gray image data into small areas, the speed of calculation can increase.

Furthermore, in the invention, it is preferable that the search section sets the histogram generated by the histogram generating section as a feature vector, calculates relative distances between the feature vectors of the pre-registered image data and the feature vector of the inputted image data, and searches the image data similar to the inputted image data among the pre-registered image date based on the calculated relative distances.

According to the invention, the search section sets the histogram generated by the histogram generating section as a feature vector, calculates relative distances between the feature vectors of the pre-registered image data and the feature vector of the inputted image data, and searches the image data similar to the inputted image data among the pre-registered image data based on the calculated relative distances.

By using the relative distances, the similarity can be calculated in an easy manner. In addition, the accuracy of search can increase.

Furthermore, the invention provides an image searching method for searching for image data similar to inputted image data among pre-registered image data, comprising:

a gray processing step of converting inputted image data into gray image data based on the gray levels of the inputted image data and the pre-registered image data;

a histogram generating step of setting one of pixels constituting the gray image data as a target pixel, calculating for each of the pixels rotation-invariant features indicating local texture feature centering on the target pixel based on the gray scale level of the target pixel and the gray levels of a plurality of neighbor pixels surrounding the target pixel in an approximate circumference shape, and generating a histogram that represents the distribution of the number of pixels of the gray image data based on the calculated features;

a searching step of searching for image data similar to the inputted image data among the pre-registered image data based on histograms of the pre-registered image data and the histogram of the inputted image data; and

a displaying step of displaying the image data similar to the inputted image data among the pre-registered image data based on the result of the search acquired in the searching for the image data.

According to the invention, when inputted image data is converted into gray image data based on the gray levels of the inputted image data and the pre-registered image data at the gray processing step, a histogram representing the distribution of the number of pixels of the gray image data is generated at the histogram generating step.

In particular, one of pixels constituting the gray image data is set as a target pixel, rotation-invariant features indicating local texture feature centering on the target pixel are calculated for each of the pixels based on the gray scale level of the target pixel and the gray levels of a plurality of neighbor pixels surrounding the target pixel in an approximate circumference shape, and a histogram is generated based on the calculated features.

When image data similar to the inputted image data is found among the pre-registered image data based on the histograms of the pre-registered image data and the histogram of the inputted image data at the searching step, the image data similar to the inputted image data among the pre-registered image data is displayed at the displaying step.

As described above, the histogram is generated based on the local pattern, and accordingly, the features that have rotation invariance and scale invariance can be used, and robustness for rotation, optical occlusion, or the like can be improved.

### BRIEF DESCRIPTION OF DRAWINGS

Other and further objects, features, and advantages of the invention will be more explicit from the following detailed description taken with reference to the drawings wherein:

FIG. 1 is a block diagram representing the mechanical configuration of an image searching apparatus;

FIG. 2 is a block diagram representing the functional configuration of an image searching apparatus;

FIG. 3 is a flowchart representing a gray image process performed by the gray processing section;

FIG. 4 is a diagram representing positional relations of a target pixel C and eight neighbor pixels N1 to N8;

FIG. 5 is a diagram representing the generated histogram visualized as a graph;

FIG. 6 is a diagram representing the data structure of a total histogram;

FIG. 7 is a flowchart representing the process to calculate the relative distance D; and

FIG. 8 is a diagram representing the example in the result of search.

### DETAILED DESCRIPTION

Now referring to the drawings, preferred embodiments of the invention will he described in detail.

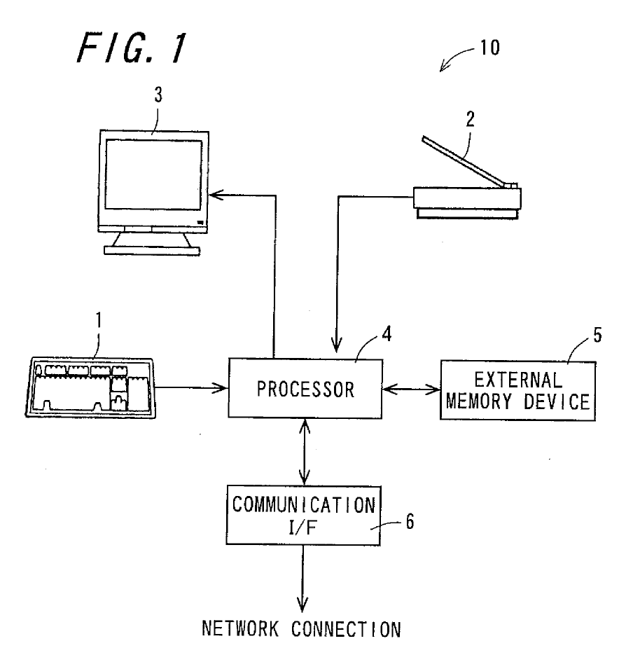

FIG. 1 is a block diagram representing the mechanical configuration of an image searching apparatus 10. The image searching apparatus 10 includes a processor 4 and an external memory device 5 storing software or the like that is used by the processor 4 for performing an actual process.

The processor 4 refers image data that is inputted (hereinafter, referred to as “input image data”) to a plurality of image data that is registered in advance (hereinafter, referred to as “registration image data”) and actually performs an image searching process for searching and displaying registration image data that is similar to the input image data and the like. The actual process of the processor 4 is performed by software that is stored in the external memory device 5. The processor 4, for example, is configured by an ordinary computer main body and the like.

The external memory device 5, for example, may be configured by a hard disk that is accessible at a high speed or the like. The external memory device 5 may be configured to use a mass-capacity device such as an optical disc for maintaining the registration image data of a large amount. In addition, temporary data or the like that is generated in each process step of the image referring process may he stored in the external memory device 5 or a semiconductor memory that is built in the processor 4.

To the image searching apparatus 10, a keyboard 1 and a display device 3 are connected. The keyboard 1 is used for inputting a direction for executing various software programs and the like.

The display device 3 performs display of an image, display of a search result, and the like based on the input image data and the registration image data.

To the image searching apparatus 10, an image scanner 2 is additionally connected. The image scanner 2 is used for reading a document in which an image is printed and inputting the input image data.

The input image data can be acquired from another device on a network through a communication I/F (interface) 6 by using data communication, other than input from the image scanner 2. The communication I/F 6 is implemented as a LAN card used for connection to the LAN (Local Area Network), a modem card that is connected to a public switched telephone network for data communication, or the like.

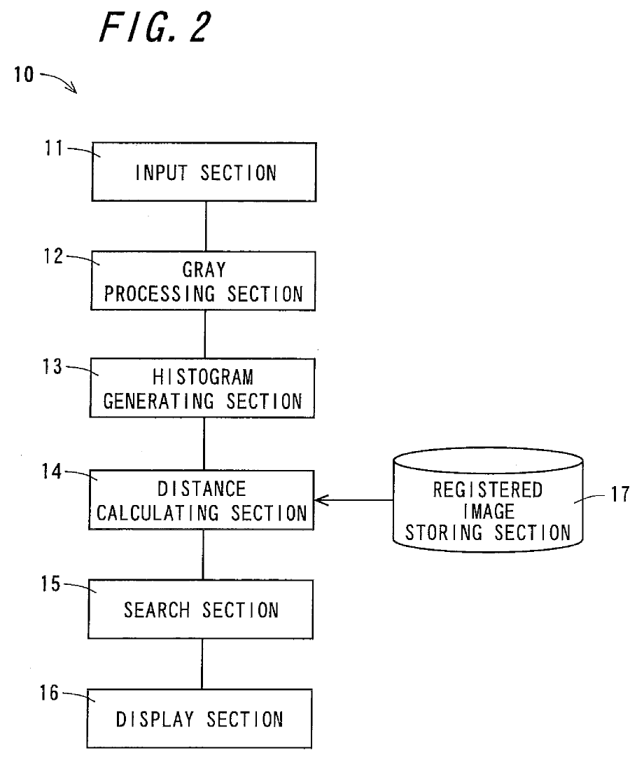

FIG. 2 is a block diagram representing a functional configuration of the image searching apparatus 10.

The image searching apparatus 10 includes an input section 11, a gray processing section 12, a histogram generating section 13, a distance calculating section 14, a search section 15, a display section 16, and a registered image storing section 17.

The input section 11 inputs the input image data and the registration image data. In the hardware configuration shown in FIG. 1, the image scanner 2, the communication I/F 6, and the like correspond to the input section 11 functionally. The registration image data is image data that has been inputted before the input image data is inputted and is stored in the registered image storing section 17.

When the input image data inputted from the input section 11 is color image data, the gray processing section 12 performs a gray process based on a luminance component so as to convert the input image data into gray image data.

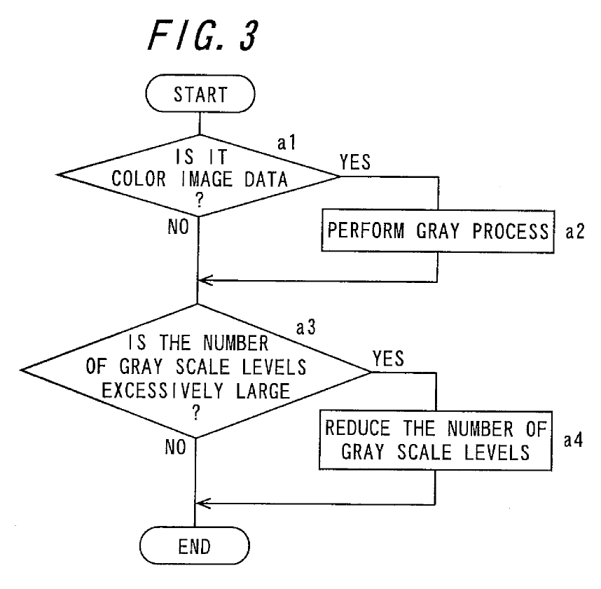

FIG. 3 is a flowchart representing a gray image process performed by the gray processing section 12.

When the input image data is inputted, it is determined in Step a1 whether the image data inputted is color image data. When the input image data is color image data, the process proceeds to Step a2. On the other hand, when the input image data is not color image data, that is, the input image data is gray image data, the process proceeds to Step a3. In Step a2, a gray process is performed based on the luminance component and converts the input image data into gray image data.

In Step a3, it is determined whether the number of gray levels of the gray image data is excessively large. The number of the gray levels of the gray image data is compared with a predetermined threshold value. When the number of the gray levels is equal to or larger than the threshold value, the number of the gray levels is determined to be excessively large, and the process proceeds to Step a4. On the other hand, when the number of the gray levels is smaller than the threshold value, the process ends.

The number of gray levels that becomes the threshold value varies depending on the size of the image data, the processing capacity of the processor 4, and the like. For example, the number of the gray levels is set to about four.

In Step a4, the number of the gray levels is reduced to a value that is equal to or smaller than a predetermined number of gray levels. Since a considerable amount of information on an image exists in intermediate gray levels, as a method of reducing the number of the gray levels of the gray scale, a decrease in the amount of the information on the image due to reduction of the number of the gray levels can be suppressed by slightly decreasing the number of the gray levels for gray scale values of the intermediate gray levels and decreasing the number of the gray levels much for other gray scale values. For example, in the case of converting 16-gray level images into 4-gray level image, the original gray scale value of 0 to 4 is converted to a new gray scale value of 0, the original gray scale value of 5 to 7 is converted to a new gray scale value of 1, the original gray scale value of 8 to 9 is converted to a new gray scale value of 2, and the original gray scale value of 10 to 15 is converted to a new gray scale value of 3.

When gray image data having smaller number of gray levels than a predetermined number of gray levels is generated by the gray processing section 12, the histogram generating section 13 generates a histogram based on the gray image data.

First, a local pattern analysis is performed for the gray image data. The local pattern is a texture operator that represents the distribution of local textures included in an image.

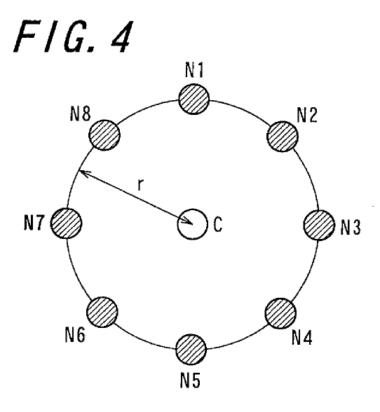

In a particular analysis process, an analysis operation is performed based on pixel values of a target pixel and eight neighbor pixels that are in neighbor positions. As shown in FIG. 4, eight neighbor pixels N1 to N8 are pixels that are located on the circumference of a circle having a radius of r from the center of the target pixel C and are located in positions that divide the circumference into eight with the center angle of 45 degrees. In addition, in the case that the peripheral pixels do not exist in the positions, it is preferable that an interpolation process is performed for the target pixel by using a double straight line interpolation method.

The pixel value of the target pixel C and the pixel values of the neighbor pixels N1 to N8 are compared with each other. In the case that the pixel value of the neighbor pixel is larger than the pixel value of the target pixel, “level 1” is acquired. On the other hand, in the case that the pixel value of the neighbor pixel is equal to or smaller than the pixel value of the target pixel, “level 0” is acquired. Accordingly, eight level values are acquired for one target pixel. Since each of the eight level values is “0” or “1”, one byte data constituted by eight bits that are configured by using each level value as one bit is generated.

For the generated one byte data, a bit shifting process is performed by circular shift centering on the target pixel, and the one byte data is converted into data that satisfies the following condition. The circular shift is a bit shifting process in which the most significant bit and the least significant bit are treated to be adjacent to each other. Thus, in the circular shift, when a value of the most significant bit is shifted upward, the value becomes a value of the least significant bit, and when a value of the least significant bit is further shifted downward, the value becomes a value of the most significant bit.

By the circular shift, bits that form the largest length of bits having consecutive “0” values in the one byte data are detected, and bits are rearranged such that the detected bits are arranged to the left side (upper side) and the rightmost (the least significant) bit becomes “1”.

The one byte data represents features of neighbor pixels located on the circumference of the circle centering on the target pixel and represents local texture information. By performing circular shift for the one byte data so as to match a predetermined condition, data after the shift represents rotation-invariable texture information.

The analysis is repeated by using a pixel apart from the target pixel by one pixel as a new target pixel, sequentially and thereby one byte data for each of all the pixels constituting the image data is generated.

In addition, to the data after the shift, a specific number representing the pattern in accordance with the arrangement pattern of the bits is assigned. For example, a specific number of “1” is assigned to the arrangement pattern of “00000001”, and a specific number of “2” is assigned to an arrangement pattern of “00000011”. After the allocation is performed, a specific number is assigned to the target pixel based on one byte data corresponding to each of the target pixels and the specific number assigned to the bit arrangement pattern of the one byte data.

As the specific number assigned to the arrangement pattern, it may be configured that the arrangement patterns are regarded as numbers of 8 digits and the specific numbers 1, 2, 3, . . . are assigned to the arrangement patterns in the order from the arrangement pattern having the smallest number to the arrangement pattern having the largest number, as described above. Alternatively, the specific number that is the same as that of an arrangement pattern may be assigned to the arrangement pattern.

When the specific numbers are assigned to all the pixels constituting the image data, an image dividing process is performed based on the specific numbers for the pixels, and a plurality of division areas each being a pixel group having a same specific number are generated.

Subsequently, a histogram of gray levels is generated for each of the plurality of division areas. The image data of the divided image is gray image data, and thus, all the pixels have gray levels (luminance levels) as pixel values. For each one division area, a histogram of gray levels is generated by using gray levels of all the pixels included therein.

In the histogram for each divided area generated here, each gray level is used as a class, and the frequency is generated as the number of pixels that are included in the class. As the class, the value of the gray level may be directly used. However, in such a case, the class changes depending on the used image data or setting of the number of gray scales. Accordingly, a number (class number) representing each class is set, and the range of gray levels included in each class is set for the class number in advance. As the frequency for each class number, the number of pixels included within the range of the gray levels set for the class number is counted.

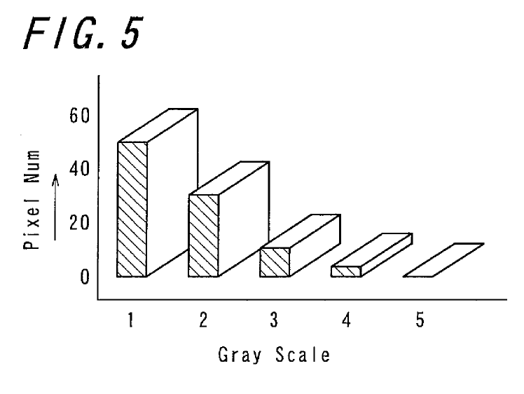

When the generated histogram is visualized as a graph, for example, as shown in FIG. 5, a graph in which the horizontal axis denotes class numbers and the vertical axis denotes frequency distributions of the numbers of pixels is generated.

In addition, according to the invention, although a process thereafter can be performed without necessarily representing the histogram as a graph, the histogram represented as a graph may be configured to be displayed by the display section 16.

One histogram is generated by generating division area histograms for all the division areas, assigning histogram numbers for identifying the division area histograms, and combining all the division area histograms. The histogram generated here includes features of all the division areas, and thus, is generated as a total histogram that represents the total features of the image data.

Since each histogram is generated in correspondence with a specific number, a value that is the same as the specific number may be assigned as the histogram number, and the histogram numbers only have to be assigned not to overlap each other.

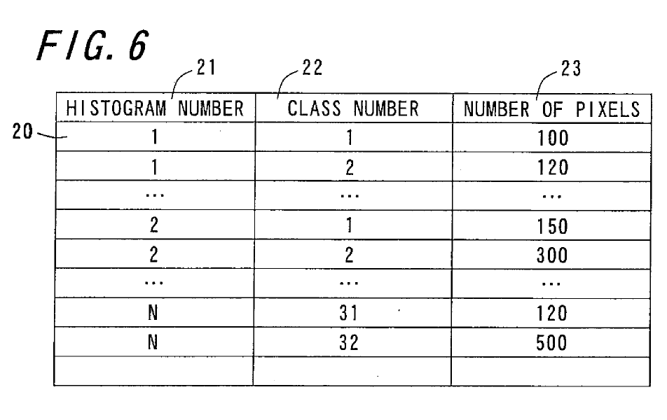

FIG. 6 is a diagram representing the data structure of a total histogram 20.

The total histogram 20 is configured by histogram numbers 21, class numbers 22, and the numbers of pixels 23 that are assigned for the division area histograms. In the example shown in FIG. 6, the division area histogram data having the histogram number of “1” is written in the order from the smallest class number 22 to the largest class number from the top. Then, when all the division area histogram data having the histogram number of “1” is written, subsequently, all the division area histogram data having the histogram number of “2” is written. Then, by repeating the writing operation, all the division area histogram data is written.

The generated total histogram 20 is stored in association with the image data in a predetermined storage area of the external memory device 5 as a feature vector of the input image data.

The generation of histograms and calculation of the feature vector for the input image data have been described as above. However, also for the registration image data stored in the registered image storing section 17, the process as described above is performed in advance at a time when a registration process is performed, and the feature vector is calculated and is stored in association with each registration image data.

The distance calculating section 14 calculates a relative distance between a feature vector (registered feature vector) associated with the registration image data that is stored in the registered image storing section 17 in advance and a feature vector (input feature vector) associated with the input image data. The relative distance between the two feature vectors represents similarity of the image data associated with the feature vectors. When the relative distance between the two feature vectors is short, the similarity of image data can be regarded to be high. On the other hand, when the relative distance is long, the similarity of the image data can be regarded to be low.

As a method of calculating the relative distance between the two feature vectors, a conventional method may be used. For example, when the input feature vector is denoted by X and the registered feature vector is denoted by Y, a relative distance D between X and Y can be calculated by using the following Equation (1).

$$D = {\sum }_{i}^{ } \frac{\vert {X}_{i} - {Y}_{i} \vert}{{X}_{i} + {Y}_{i}} \qquad ( 1 )$$

Here, Xi and Yi are the i-th elements of the respective feature vectors.

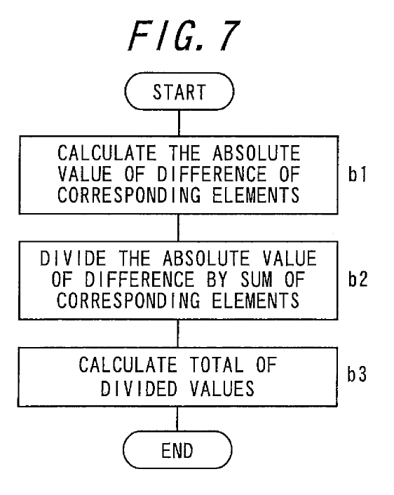

The calculation of the relative distance D by using Equation 1 will be described in more details with reference to a flowchart shown in FIG. 7.

In Step b1, an input feature vector and a registered feature vector used for the calculation are read from the external memory device 5, the numbers of pixels that are corresponding elements are extracted from the feature vectors, and the absolute value of a difference between the extracted numbers of pixels is calculated. As a corresponding element, an element written in the uppermost position is set as a first element based on the data structure shown in FIG. 6, and the same i-th elements are extracted from the respective feature vectors. Then, the absolute value of a difference between the i-th elements is calculated. This process is sequentially repeated from the top, and the absolute values of differences are calculated for all the elements.

In Step b2, the calculated absolute values of differences are divided by sums of the elements that are used for calculating the differences. In other words, the absolute value of the difference between the i-th elements is divided by a sum of the i-th elements. By repeating this division process for all the elements, a total of all the divided values is calculated in Step b3. The calculated total becomes a relative distance between the input feature vector and the registered feature vector.

Next, a new registered feature vector is read from the registered image storing section 17, and a relative distance between the input feature vector and the new registered feature vector is calculated as above described. When the relative distances between the registered feature vectors for all the registration image data that are registered and the input feature vector are calculated, registration image data similar to the input image data is searched by the searching section 15.

The searching section 15 arranges all the calculated relative distances in the order from the shortest to the longest and determines a registered feature vector that has the shortest relative distance from the input feature vector. Then, the searching section regards the image data associated with the determined registered feature vector as the registration image data having the highest similarity and determines the registration image data as the result of the search.

When there are a plurality of registered feature vectors having the same distance from the input feature vector, it is preferable that all the plurality of registration image data associated with the plurality of registered feature vectors having the same distance is displayed, so that a user can select any registration image data.

As the result of search, instead of the registration image data having the highest similarity, it may be configured that a predetermined number of the registration image data from the shortest relative distance side are selected and set as the result of search. When a plurality of the registration image data are set as the result of search as described above, the selected registration image data and the ranks of similarity determined based on the relative distances of the registration image data are needed to be included in the result of search.

When the result of search is outputted by the search section 15, the display section 16 displays an image acquired from visualizing the result of search.

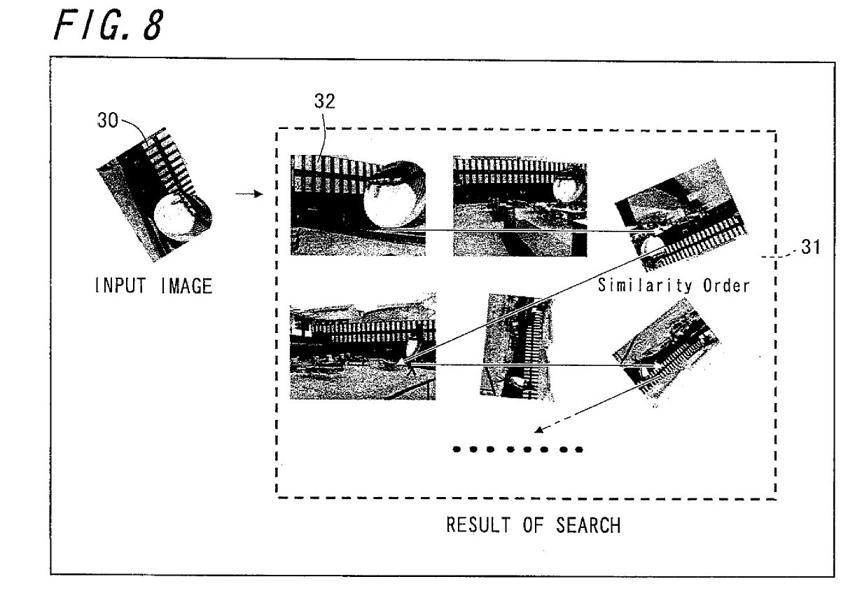

As the visualized image, for example, as shown in the display example shown in FIG. 8, an image 30 on the basis of the input image data is displayed on the left side of the screen, a search result displaying area 31 is arranged on the right side of the screen, and registered images 32 on the basis of the registration image data selected as the result of search are displayed in the search result displaying area 31. When a plurality of the registration image data are included in the result of search, it is preferable that the registered images are displayed in accordance with the ranks of similarity.

In the example shown in FIG. 8, although the input image is inputted in a state that the input image is rotated to be tilted, a registered image that is not rotated is found in the result of search.

In addition, when an image photographed by a camera is searched for, even in the case that an image acquired from photographing the subject of a registered image at a different angle is set as the input image, the image acquired from photographing the same subject is found as the result of search.

According to the invention, the following advantages can be acquired.

The search process is performed based on the gray processed image data, and accordingly, information on the color is not needed, and the range of application can be widened.

The histogram is generated based on the local pattern, and accordingly, the features that have rotation invariance and scale invariance can be used, and robustness for rotation, optical occlusion, or the like can be improved.

The local pattern is calculated based on a minute area including a target pixel and neighbor pixels thereof, and accordingly, a high-speed process can be performed, and application to a real time process can be effectively made.

A search process according to person's visual features can be performed, and accordingly, the result of search with high precision can be acquired.

The invention may be embodied in other specific forms without departing from the spirit or essential features thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image searching apparatus that searches for image data similar to inputted image data among pre-registered image data, comprising:
a gray processing section that converts the inputted image data into gray image data based on gray levels of the inputted image data and the pre-registered image data;
a histogram generating section that sets one of pixels constituting the gray image data as a target pixel, calculates for each of the pixels rotation-invariant features indicating local texture feature centering on the target pixel based on the gray level of the target pixel and the gray levels of a plurality of neighbor pixels surrounding the target pixel in an approximate circumference shape, and generates a histogram that represents the distribution of the number of pixels of the gray image data based on the calculated features;
a search section that searches for image data similar to the inputted image data among the pre-registered image data based on histograms of the pre-registered image data and the histogram of the inputted image data; and
a display section that displays the image data similar to the inputted image data among the pre-registered image data based on the result of the search performed by the search section.

2. The image searching apparatus of claim 1, wherein the histogram generating section compares the gray level of the target pixel with the gray levels of the neighbor pixels so as to represent the result of comparison for each of the neighbor pixels as a binary logic value, generates byte data by aligning the logic values of the results of comparison in bits in accordance with the order of arrangement of the neighbor pixels, and calculates as the rotation-invariant features byte data in which arrangement of bit values is changed so as to satisfy a predetermined condition by circularly shifting each bit value of the generated byte data.

3. The image searching apparatus of claim 2, wherein the histogram generating section determines an arrangement pattern of bit values of the changed byte data for each of the pixels, divides the gray image data into pixel groups each formed of pixels having a same arrangement pattern, generates a histogram in which gray levels are set as classes for each of the pixel groups and the numbers of pixels included in the classes are set as frequencies, and generates a histogram representing the distribution of the number of the pixels of the total gray image data by combining the histograms generated for each of the pixel groups.

4. The image searching apparatus of claim 3, wherein the search section sets the histogram generated by the histogram generating section as a feature vector, calculates relative distances between the feature vectors of the pre-registered image data and the feature vector of the inputted image data, and searches the image data similar to the inputted image data among the pre-registered image date based on the calculated relative distances.

5. An image searching method for searching for image data similar to inputted image data among pre-registered image data, comprising:
a gray processing step of converting inputted image data into gray image data based on the gray levels of the inputted image data and the pre-registered image data;
a histogram generating step of setting one of pixels constituting the gray image data as a target pixel, calculating for each of the pixels rotation-invariant features indicating local texture feature centering on the target pixel based on the gray scale level of the target pixel and the gray levels of a plurality of neighbor pixels surrounding the target pixel in an approximate circumference shape, and generating a histogram that represents the distribution of the number of pixels of the gray image data based on the calculated features;
a searching step of searching for image data similar to the inputted image data among the pre-registered image data based on histograms of the pre-registered image data and the histogram of the inputted image data; and
a displaying step of displaying the image data similar to the inputted image data among the pre-registered image data based on the result of the search acquired in the searching for the image data.
